(19) United States
(12) Patent Application Publication
(10) Pub. No.: US 2006/0057539 A1
(43) Pub. Date: Mar. 16, 2006

(54) Dental hygiene device

(76) Inventor: Diego Sodo, Napoli (IT)

Correspondence Address: Striker Striker & Stenby, 103 East Neck Road, Huntington, NY, 11743, US

(21) Appl. No.: 10/478,532

(22) PCT Filed: May 16, 2002
(86) PCT No.: PCT/IT02/05391

§ 371 Date: Nov. 20, 2003

(30) Foreign Application Priority Data
May 23, 2001 (IT) MI01A001083

(51) Int. Cl. A61C 17/02

(52) U.S. Cl. 433/80; 601/162

(57) ABSTRACT

The dental hygiene device comprises means for connecting it to n water tap and means for delivering the water in a way suitable for cleaning teeth, which comprises means for adjusting the pressure of the water capable of being associated with and disassociated from the connection means to deactivate and activate, respectively, static aeration means of the water operatively associated with the connection means.

The present finding refers to a dental hygiene device.

As is known, currently dental hygiene is carried out for the most part with two types of instruments: electric toothbrushes and water sprayers, besides the use of accessories such as dental floss and the like.

Whereas electric toothbrushes are in the most part suitable for the removal of bacterial plaque, water sprayers are mainly suitable for removing specks of food which can remain between the teeth and at the same time for effectively massaging the gums.

Current water sprayers, in turn, can be subdivided into two types.

The first type of water sprayer which uses electromechanical apparatus, such as pumps, switches and the like, foresees the presence of a tank from which the pump, when activated, draws the liquid (water or water and collutory) to be sent to the spray nozzle.

The second type of water sprayer is that which foresees the use of tap water as a water source and therefore excludes the use of pumps, electromechanical devices and the like and, above all, the need for an electrical power supply for the connection thereof and for their operation.

In the case of water sprayers of the electric type, amongst the drawbacks there is the use of electrical current and the risks which derive from its use.

Moreover, electrical pumping systems are usually noisy and difficult to carry around.

Added to the drawbacks there is the fact that the limited capacity of the water or collutory containers means that they have to be filled frequently, whereas the use of electromechanical parts increases the possibility of malfunction of the water sprayers.

Last but not least, it should also be remembered that water sprayers of the electric type are bulky and have extremely high costs.

Water sprayers of the second type, that is those which are connected directly to a tap, also have numerous drawbacks.

Amongst these, we recall the fact that such water sprayers do not usually protect the user from the use thereof with a high pressure which can create serious damage to fillings or gums which are blasted by high-pressure water jets.

Indeed, the adjustment of the pressure of these water sprayers is usually obtained by manually adjusting, according to the expertise of the user, the opening and closing of the hot and/or cold water tap.

From what has been said it is easy to understand how the adjustment of two taps is rather difficult particularly in the initial step of use of the water sprayer.

In other words, such devices do not usually have adequate, simple and functional safety systems which protect the user from high-pressure water jets which can cause numerous drawbacks.

Moreover, another drawback of water sprayers which can be connected to a tap is that of not being able to be connected to and disconnected from said tap simply and quickly without altering or even causing the elimination of the possible aerator which taps currently have at their end.

Last but not least, water sprayers are equipped with aerators which, due mainly to their size, tarnish the highly desirable appearance of expensive tap systems with which they are associated.

Consequently, such water sprayers require either the exclusion of the aerator present on the tap or the use thereof through extremely complex, overly visible and bulky, as well as expensive connection systems, which give the water sprayer itself limited use or which make them usable only on predetermined taps by the user.

The task proposed of the present finding is that of eliminating the aforementioned drawbacks of water sprayers of the known type.

In this task, an important purpose of the finding is to come up with a dental hygiene device which has extremely flexible use so that it can be used in any public or private place which is connected to the water mains without the use of electrical energy and without having to modify the operation of the previously installed taps.

Another purpose of the finding is to realise a dental hygiene device which is extremely simple and functional to realise, whilst still being capable of providing the user with all the necessary safety in order to guarantee the best possible dental hygiene, independently of the water pressure present in the building.

Another purpose of the finding is to realise a water sprayer which allows aerated water to run from the tap when it is disconnected from it, without having moving parts which, in time and with the presence of limescale, can affect the operation both of the aerator and of the water sprayer.

A further purpose of the finding is to realise a dental hygiene device which can use additional products, such as bleaching agents, disinfectants and the like in a direct and constant manner without having to be replenished for relatively long periods of time.

Another purpose of the finding is to realise a dental hygiene device which can combine the function of a water sprayer and an electric toothbrush and which, moreover, is not subject to limescale deposits which can alter or prevent its operation in time.

The last but not least purpose of the finding is to realise a dental hygiene device in which the aerator is so small in size that it does not tarnish the appearance of the existing taps.

This task, as well as these and other purposes, are achieved by a dental hygiene device comprising means for connecting it to a water tap and means for delivering said water in a suitable manner for cleaning teeth, characterised in that it comprises means for adjusting the pressure of said water capable of being associated with said connection means to deactivate and activate, respectively, static aeration means of said water operatively associated with said connection means.

Further characteristics and advantages of the invention shall become clearer from the description of a preferred but not exclusive embodiment of the device according to the finding, illustrated for indicating and not limiting purposes in the attached drawings in which:

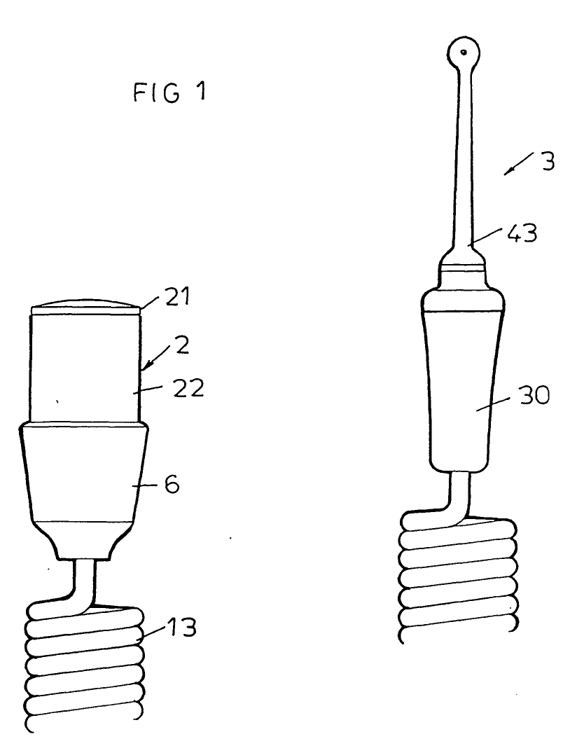

FIG. 1 is a schematic view of the water sprayer according to the finding;

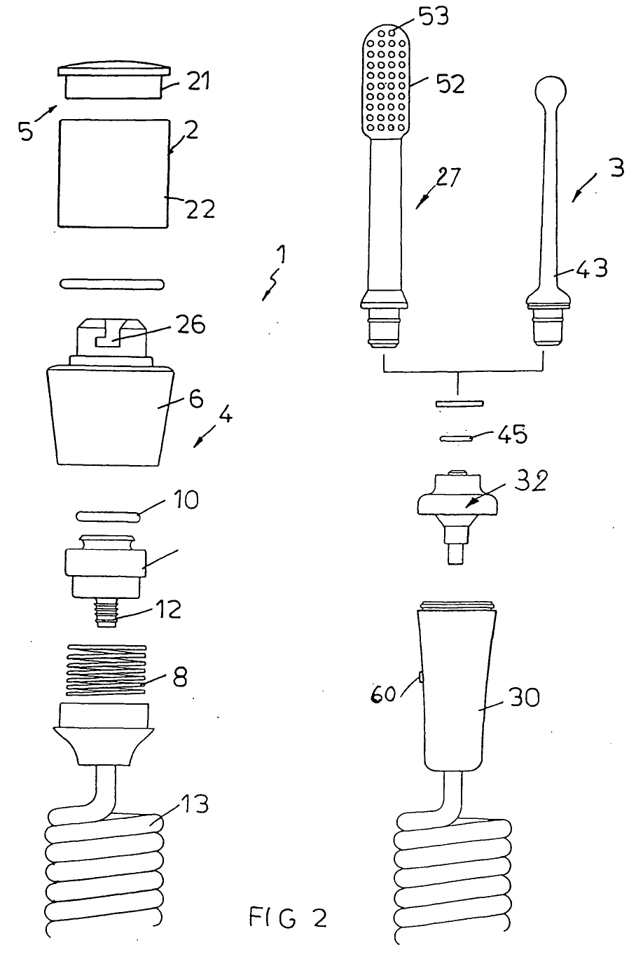

FIG. 2 is an exploded view of the water sprayer represented in FIG. 1 according to the finding;

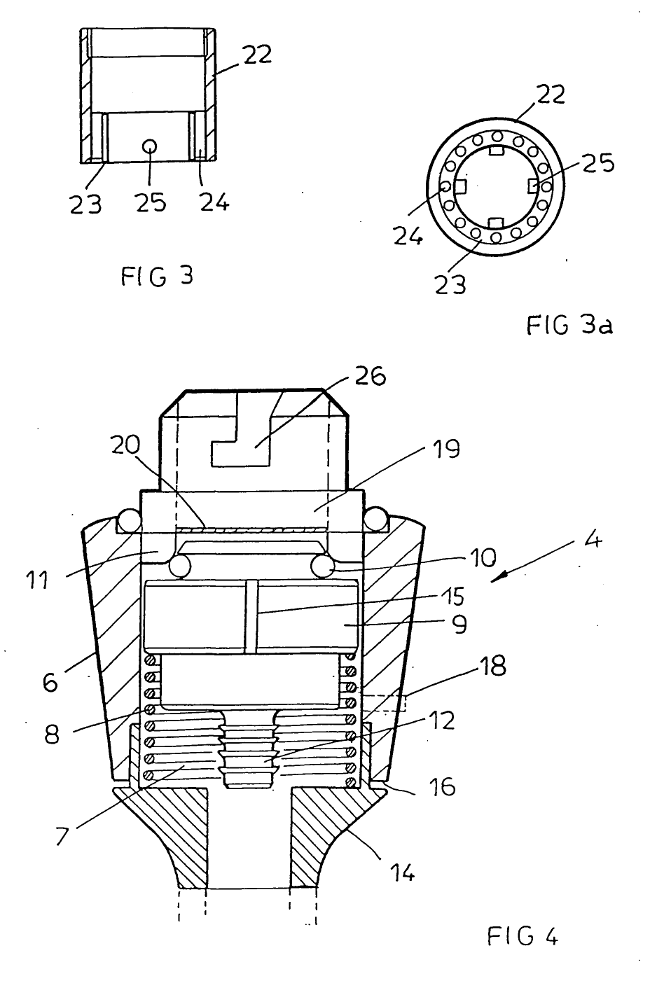

FIG. 3 is a section view of the connection means of FIG. 2 according to the finding;

FIG. 3a is a plan view from below;

FIG. 4 is a section view of the pressure adjustment means of FIG. 2 according to the finding;

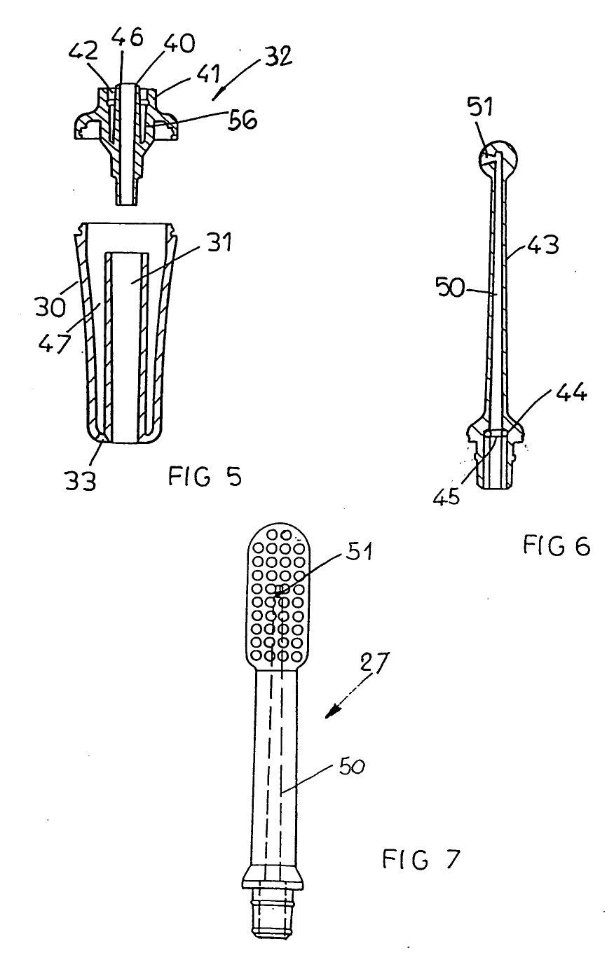

FIG. 5 is a section view of the delivery means of FIG. 2 according to the finding;

FIG. 6 is a section view of the delivery nozzle of FIG. 2 according to the finding;

FIG. 7 is a front view of the water delivery means equipped with bristles according to the finding;

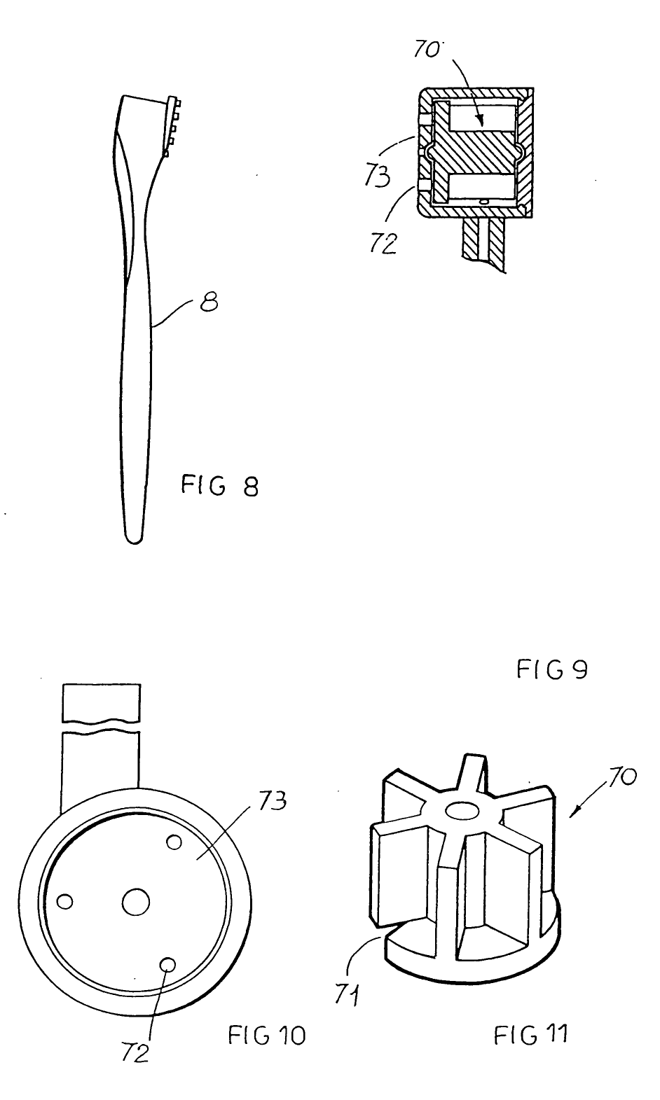

FIG. 8 is a side view of the handle for engaging the delivery means represented in FIG. 7 according to the finding;

FIG. 9 shows a different embodiment of the delivery nozzle in a cross section view;

FIG. 10 is a partial plan view from below of the nozzle of FIG. 9 according to the finding;

FIG. 11 shows the rotor inside the nozzle of FIG. 9 to get the pulsating effect of the water.

With reference to the figures described above the dental hygiene device according to the finding, wholly indicated with the reference numeral 1, comprises means 2 for connecting it to a water tap, not represented, and means 3 for delivering the water in a manner suitable for cleaning teeth.

Suitably, the device comprises means for adjusting the pressure of the water 4 which can easily be associated with and disassociated from the means 2 for connecting to the tap so as to be able, during association to deactivate, and during disassociation to activate, respectively, the static aeration means 5 of the water operatively associated with the connection means 2.

In particular, the means for adjusting the pressure of the water comprise a gudgeon 6 with an inner chamber 7 in which a cylinder 9 is mobile against and through the action of elastic means, and in particular of a spring 8.

The cylinder 9 on one side has an O-ring 10, suitable for carrying out a watertight seal with the inner surface 11 of the gudgeon 6, and on the opposite side has an attachment element 12 with a flexible tube 13 suitable for transporting water to the delivery means 3.

The spring 8 and consequently the cylinder 9 are held inside the chamber 7 through a cap 14 for closing said chamber.

In particular, the cylinder 9 has at least one channel and in particular two diametrically opposed channels arranged around the perimeter to allow the downflow of the water inside the inner chamber 7 and then towards the outside of it, when a pressure greater than the calibrated elastic force of the spring 8 is reached.

More precisely, in a normal situation of use with suitable water pressure for cleaning teeth, the cylinder 9 is pushed by the precalibrated spring 8 against the edge 11 of the gudgeon carrying out, through the ring 10, a watertight seal so that the water coming from the tap passes into the cylinder 9 and from here to the flexible tube 13.

In the case in which the pressure exceeds the safety levels, the water shall apply a push against the cylinder 9 which, squashing the spring 8, will tend to move away from the surface 11 of the gudgeon thus allowing the water to flow into the chamber 7 to then come out through the space present between the base 16 of the gudgeon and the cap 14 for closing said gudgeon.

Suitably, the gudgeon also has a device 18 for blocking and/or adjusting the spring 8 so as to be able to obtain, according to requirements, the pressure and the amount of water which have been predetermined by the user.

In any case, the predetermined pressure and amount of water can be obtained with any device which can be positioned anywhere inside the finding.

Advantageously, moreover, the gudgeon 6 has a seat 19 inside of which a tablet realised with a substance suitable for cleaning teeth can be contained.

The seat 19 has a diametrical width equal to or less than the diametrical width of the passage of the gudgeon inside the chamber 7, in such a way that the possible flaking into pieces of the tablet does not cause the accidental blocking of the passage of the water.

For this reason, the seat 19 has its base for supporting the tablet realised, for example, with a wire gauze or another filtering element suitable for the purpose indicated with 20.

Advantageously, moreover, in the case of a dental hygiene substance in the form of paste, gel or other, the seat 19 can be equipped with elements for the controlled release of such a substance.

Such elements (not represented) can be tabs developing inclined from the walls or else the filtering element itself 20 with more or less separated openings.

The static aeration means 5 comprise an aerator 21, realised in a per se known way through the association of many filtering elements with each other, which is housed inside a cylindrical body 22.

The cylindrical body 22 has inside of it a small annular zone 23 equipped with a plurality of axial channels 24 suitable for feeding air into the body 22, during the passage of water inside of it, when the pressure adjustment means, and in particular the gudgeon 6 is not associated with the cylindrical body 22.

Thanks to this solution it is possible to use the filtering elements which make up the aerator 21 without the support body which is replaced by the structure of the cylindrical body itself with a consequent substantial reduction in encumbrance.

More precisely, the passage of the water into the body 22 determines a depression which draws air through the channels 24 inside the body 22 and, therefore, inside the aerator 21 so as to carry out an aerating effect upon the water.

In this way, the tap and the flow of water coming out from it shall carry out the same function as traditional taps equipped with an aerator.

As the gudgeon 6 is connected to the body 22 the axial channels 24 shall close thus allowing the passage of the water into the gudgeon and thus into the flexible tube 13.

In a non-represented constructive variant, the channels 24 are arranged with a radial extension with respect to the body 22 and the connection between the gudgeon 6 and the cylindrical body 22 takes place on a side portion of said cylindrical body.

The small annular zone has on the inside two pins 25 which are diametrically opposed to each other and suitable for the engagement in respective slots 26 present on the gudgeon to allow a bayonnet coupling between the two elements, allowing excellent precision of connection and of seal with a slight rotation of one element with respect to the other.

The delivery means 3 comprise a grip 30 having axially inside of it a duct 31 for the passage of the flexible tube 13 which is associated with a closing head 32 of the grip 30.

Advantageously, as shall be better specified hereafter, the grip has a water discharge hole 33 which is arranged on the opposite side to the grip with respect to the closing head 32 thereof.

In turn, the closing head has a rigid tube 40 for transporting water which has a smaller section with respect to the diameter of the flexible tube 13.

The rigid tube 40 defines with the collar 41 of the head 32 a seat 42 for engagement with a water delivery nozzle 43.

The delivery nozzle 43 has inside of it an abutment 44 for engagement with an elastically deformable O-ring 45.

The ring 45 therefore carries out a watertight seal between the abutment 44 and the front surface 46 of the rigid tube 40.

In this way, when the pressure inside the rigid tube 40 increases, due to the difficulty for the water to come out of the nozzle 43, there will be a slight displacement of the nozzle 43 suitable for allowing the water to go past the O-ring 45 which is in a position slightly separated from the face 46.

In this way the water through one or more communication channels 56 between the seat 42 and the cavity 47 of the grip 30 will allow the outflow of the water through the hole 33.

Such a sealing system is a further system for guaranteeing the maintenance and control of the pressure which can be present by itself or connected to other control systems which have already been quoted.

The nozzle 43 has, moreover, inside of it a tapered duct 50 which, extends beyond the outlet hole 51 arranged substantially perpendicular to it.

In this way there will be a breaking of the end water jet and, thanks to the fact that the hole 51 has a substantially conical configuration, there can be a water jet of the linear or open type flowing out of it depending upon the pressure.

On the grip 30 a button 60 can, moreover, be foreseen to obtain a jet of the linear type, a jet of water of the shower type, or the total closing of the outlet of water from the nozzle.

Advantageously, the delivery nozzle 43 can be replaced with another delivery nozzle, indicated with 27 which can have near to the outlet hole 51 a widening 52 supporting a plurality of bristles 53, so as to combine a mechanical brushing of teeth together with a jet for removing food, both from the bristles themselves and from the gaps between the teeth.

The delivery nozzle 43 can, moreover, in the end zone have a rotating rotor 70 which has a missing part 71 suitable for allowing the passage of water to three holes 72 present on the base 73 for housing the rotor to realise a pulsating effect of the water and to address the jet of this water along inclined directions so as to create a combination of forces on leftover food suitable for removing it from the spaces between the teeth in which it is housed instead of wedging it even further therein.

Advantageously, the means for connecting to a tap 2, like the means for adjusting the pressure 4 and the aeration means 5 which are arranged before the flexible tube 13 can also be used in the case of an electric toothbrush of the traditional type with mobile bristles to allow, besides the cleaning through these bristles, also a jet of water suitable for operating with the electric toothbrush to optimise the cleaning of teeth and to remove food from the gaps between the teeth.

It should also be said that the delivery nozzle 2 with the bristles 53 can be inserted into a handle 8 suitable for allowing the use thereof as a traditional toothbrush according to the choice and the requirements of the user.

The finding thus conceived is susceptible to numerous modifications and variants all covered by the present inventive concept; moreover, all of the details can be replaced with technically equivalent elements.

In practice, the materials used, as well as the sizes, can be whatever according to the requirements of the state of the art.

1. Dental hygiene device comprising means for connecting it to a water tap and means for delivering said water in a way suitable for cleaning teeth, characterised in that it comprises means for adjusting the pressure of said water capable of being associated with and disassociated from said connection means to deactivate and activate, respectively, static aeration means of said water operatively associated with said connection means.

2. Dental hygiene device according to claim 1, characterised in that said means for adjusting the pressure of said water comprise a gudgeon having an inner chamber in which a cylinder is mobile against and through the action of elastic means, said cylinder having on one side an O-ring for sealing said gudgeon and on the opposite side an element for connecting with a flexible tube for transporting said water to said delivery means.

3. Dental hygiene device, according to any one of the previous claims, characterised in that said elastic means comprise a calibrated spring suitable for keeping said cylinder against said gudgeon carrying out a watertight seal, through said O-ring, up to a predetermined pressure of said water.

4. Dental hygiene device according to any one of the previous claims, characterised in that said cylinder has at least one channel arranged around the perimeter for the outflow of said water in said chamber and towards the outside of it once a predetermined pressure is reached suitable for separating said cylinder from said gudgeon compressing said calibrated spring.

5. Dental hygiene device according to any one of the previous claims, characterised in that it comprises a device for blocking and/or adjusting said spring to obtain the predetermined pressure and amount of said water delivered.

6. Dental hygiene device according to any one of the previous claims, characterised in that said gudgeon has a containment seat with controlled release elements of a dental hygiene substance.

7. Dental hygiene device according to any one of the previous claims, characterised in that said static aeration means comprise an aerator housed inside a cylindrical body having inside of it a small annular zone equipped with a plurality of axial channels for feeding air inside said body during the passage of said water when said means for adjusting the pressure are not associated with said cylindrical body.

8. Dental hygiene device according to any one of the previous claims, characterised in that said channels are radial and that said means for adjusting the pressure connect with a side portion of said body.

9. Dental hygiene device according to any one of the previous claims, characterised in that it comprises two or more preferably opposite pins inserted in said annular zone for bayonnet connection with respective slots present on said gudgeon.

10. Dental hygiene device according to any one of the previous claims, characterised in that said delivery means comprise a grip having axially inside of it a duct for the passage of said flexible tube associated with a closing head of said grip, said grip having a discharge hole for said water arranged on the opposite side to said closing head.

11. Dental hygiene device according to any one of the previous claims, characterised in that said closing head has a rigid tube for transporting said water with a much smaller section with respect to the diameter of said flexible tube, said rigid tube defining with the collar of said head a seat for engagement with a nozzle for delivering said water, said seat being in communication with said discharge hole.

12. Dental hygiene device according to any one of the previous claims, characterised in that said nozzle has an abutment for engaging with an elastically deformable O-ring operating against the front surface of said tube.

13. Dental hygiene device according to any one of the previous claims, characterised in that said nozzle has inside of it a tapered duct extending beyond the outlet hole for said water arranged perpendicular to it.

14. Dental hygiene device according to any one of the previous claims, characterised in that said delivery nozzle has a rotating rotor for feeding one or more outlet holes to realise a pulsating effect and to address the jet of water along preferably inclined directions.

15. Dental hygiene device according to any one of the previous claims, characterised in that said delivery nozzle is equipped with bristles for cleaning said teeth.

16. Dental hygiene device according to any one of the previous claims, characterised in that said bristles are actuated by an electromechanical mechanism.

17. Dental hygiene device according to any one of the previous claims, characterized in that said rotor is contained in said delivery means of an electric or manual toothbrush.

18. Dental hygiene device according to any one of the previous claims, characterised in that said rotor is associated with said delivery nozzle with interchangeable bristles with said electric or manual toothbrush.
